(19) United States
(12) Patent Application Publication
(10) Pub. No.: US 2020/0077079 A1
(43) Pub. Date: Mar. 5, 2020

(54) PORTABLE DEVICE FOR ACQUIRING IMAGES OF AN ENVIRONMENT

(71) Applicant: Soletanche Freyssinet, Rueil Malmaison (FR)

(72) Inventors: Guy PERAZIO, Saint-Romans (FR); Jose Peral, Moirans (FR); Serge Valcke, Apprieu (FR); Luc Chambaud, Moirans (FR)

(73) Assignee: Soletanche Freyssinet, Rueil Malmaison (FR)

(21) Appl. No.: 16/512,430

(22) Filed: Jul. 16, 2019

(30) Foreign Application Priority Data
Jul. 17, 2018 (FR) 18 56591

(51) Int. Cl. H04N 13/282; G06T 17/05; H04N 5/247; H04N 5/225

(52) U.S. Cl. CPC H04N 13/282; G06T 17/05; G06T 2210/61; H04N 5/2252; H04N 5/247

(57) ABSTRACT

Portable device (5) for acquiring images of an environment, in particular a tunnel (85), the device comprising an acquiring module (10) comprising a rod (12) and at least two acquiring stages (25a-c) placed at different heights on the rod, each acquiring stage comprising a plurality of cameras (20) configured to each acquire an image of the scene, the viewing axes (27) of the cameras of an acquiring stage being angularly distributed about the axis of the rod so that the acquired images overlap angularly.

The present invention relates to a device for acquiring images, in particular with a view to producing a geo-referenced digital model of an underground installation, and to a method for producing such a digital model.

Work, for example for maintenance purposes, in the tunnels of an underground installation, for example a sewer network, is generally made complex by the crampedness of the tunnels, and the dampness and darkness thereof. Progression of operators through such tunnels therefore often proves to be slow and their work is complicated thereby.

In order to anticipate difficulties and to optimize working conditions, precise knowledge of the topography of the underground installation is required. In particular, it is to a question of precisely inventorying, prior to the work, the position of specific zones in the underground installation, for example zones in which the tunnels are narrow, along an itinerary starting from a surface access and leading to the location where the work must be carried out. For example, narrow zones result from a decrease in the distance between the walls of a tunnel, or from crowding of the tunnel with pipes and/or cables that are placed therein.

Furthermore, in many cities, the total length of the tunnels of sewer networks is typically larger than one-thousand kilometers. Plans of these networks exist, but they are often incomplete. Specifically, many modifications to the tunnels may have been made in years, or even centuries past, without however being precisely referenced in the plans. Furthermore, the latter provide information only in two dimensions, this not allowing the position of the zones of interest to the work of the operators to be precisely determined. Knowledge of sewer networks is therefore often only partial.

There is therefore a need to produce a 3-D digital model of an underground installation, which model will preferably be geo-referenced in an absolute reference system, so as to facilitate work in this underground installation, which is for example a sewer network.

The invention aims to meet this need, and proposes to this end a portable device for acquiring images of a scene, the device comprising an acquiring module comprising a rod and at least two acquiring stages placed at different heights on the rod, each acquiring stage comprising a plurality of cameras configured to each acquire an image of the scene, the viewing axes of the cameras of an acquiring stage being angularly distributed about the axis of the rod so that the acquired images overlap angularly.

An operator moving through an environment, for example a tunnel, in particular of an underground installation, may thus acquire a plurality of images of a scene of the environment by means of the acquiring device. Subsequently, by digitally correlating the acquired images using a method well known to those skilled in the art, such as photogrammetry, an elementary 3-D model of each acquired scene may be established. By progressing through the environment, so as to acquire scenes that are continuous with one another, then by assembling the elementary digital models, a continuous 3-D digital model of the environment may thus be generated.

The term “scene” must be understood to mean the portion of the environment able to be observed by the device when the latter is immobile in a given location.

Preferably, the rod is suitable for being carried by an operator moving through the tunnel and comprises, in the lower portion thereof, a foot allowing it to be stood on the ground during the acquisition of the images.

As a variant, the device, in particular the rod, may comprise a fastening member for mounting the device on an apparatus, in particular a vehicle, a cleaning machine, or an airplane, or a drone. It may be movable during movement with respect to the apparatus. The apparatus may comprise a means for guiding the device. For example, the apparatus may comprise a rail on which the device is translatably movable by means of a winch. The rail may be deployable, for example telescopically. The deployed length of the rail may be larger than or equal to 3 m, and for example larger than or equal to 5 m. The rail may for example be introduced via a sewer manhole cover and be deployed in the manhole located under the manhole cover. The device may be moved along the rail in the manhole in order to acquire scenes of the manhole.

Preferably, the viewing axes of the cameras of an acquiring stage are angularly distributed about the axis of the rod so that the images acquired by two angularly consecutive cameras of a stage overlap angularly.

The overlap of the images allows them to be processed subsequently by image correlation, and in particular by photogrammetry.

Preferably, the angular overlap between images acquired by two consecutive cameras of a stage is larger than 70%, or even larger than 80%, and for example larger than 90%. The angular overlap may be calculated:
optionally, by projecting an image acquired by one of the cameras into a plane a normal of which is parallel to the viewing axis of the other camera, then
by matching, for example by image correlation, the optionally projected image and the other image acquired by the other camera, so as to determine the common zone between the optionally projected image and the other image, and
by expressing in percent, the ratio of the number of pixels of the matched zone to the number of pixels of the other image.

For example, the projecting step described above is carried out when the angle between the viewing axes of the two consecutive cameras is larger than 5°.

Preferably, the device comprises at least three acquiring stages. Thus, the acquisition of the environment is improved by increasing the number of viewpoints. By photogrammetric processing of the images thus acquired, the precision of the calculation of the geometric coordinates of the elementary 3-D model of each scene seen by the device is improved. Preferably, the device comprises three acquiring stages, this achieving an optimum compromise between the precision of the elementary 3-D model and the duration of the photogrammetric processing.

Preferably, the cameras of each stage are regularly distributed about the longitudinal axis of the rod.

Preferably, the cameras of each stage are distributed about the longitudinal axis of the rod, over a total angular sector comprised between 90° and 210°, preferably comprised between 150° and 190°, and in particular equal to 180°. An angularly uniform acquisition of the images is then ensured. During the photogrammetric processing, it is thus possible to limit image-correlation artefacts related to a nonuniform spatial distribution of the information to be processed. The angle measured about the longitudinal axis, between two viewing axes of angularly consecutive cameras, may be comprised between 90° and 110°.

The cameras of the various acquiring stages may be distributed with an identical angular distribution.

Preferably, the spacing between the acquiring stages is adjustable. For example, when the device is used in a tunnel, it is thus possible to adapt the image-capturing configuration depending on the shape and/or the crampedness of the tunnel. The spacing between two consecutive acquiring stages, measured along the longitudinal axis of the rod, may be comprised between 0.4 m and 0.8 m. Moreover, the maximum length of the rod is preferably smaller than 2.5 m, preferably smaller than 2 m, or even smaller than 1.2 m. In particular, the rod may be telescopic, in particular in the portion thereof located under the camera stages. Its length may thus be modified during the progression through the tunnel, depending on the local variation in ceiling height.

The acquiring stages may be translationally and/or rotationally movable with respect to one another. In particular, they may only be translationally movable with respect to one another, in order to be immobilized with the desired spacing.

Preferably, the cameras of an acquiring stage are fixed with respect to one another. Preferably, in one configuration of the device, the cameras of each of the acquiring stages are fixed with respect to one another.

The cameras of an acquiring stage may be placed in the same plane, preferably one normal to the axis of the rod. In particular, the viewing axes of the cameras of the stage may be placed in the same plane. The viewing axes of the cameras of a stage may have a common intersection, in particular one at a point located on the longitudinal axis of the rod. In one variant, they may form the generatrices of a cone of revolution the axis of which is collinear with that of the rod.

Moreover, two cameras of two different acquiring stages may have viewing axes contained in a plane containing the axis of the rod.

Preferably, the acquiring module preferably comprises at least six, preferably at least ten, preferably at least twelve, and for example fifteen cameras. At least one of the acquiring stages may comprise a least three, preferably at least four, and in particular five cameras. Preferably, the acquiring stages comprise an identical number of cameras. Thus it is ensured that the acquisition of the images is uniform over the entire height of the acquiring module.

Preferably, the cameras of at least one acquiring stage are identical, so as to simplify the photogrammetric processing of the images.

A camera is an apparatus for acquiring digital images. The image-acquiring apparatus may acquire a continuous film, formed of sequences of images. It may also or as a variant acquire photographic images. For example, the camera may be a portable camera, for example of trademark GoPro. It may be a still camera, for example a reflex camera. The camera may be removable in order to be removed from the acquiring module. For example, depending on the dimensions of the environment, for example a tunnel to be imaged, the cameras mounted on the rod may be replaced by other cameras having an objective of different focal length. Each camera may comprise an autofocus. The apertures of the cameras may be the same, and vary in concert or adapt automatically to the received light. The cameras may have different focal lengths or, preferably, identical focal lengths.

Each camera may be configured to generate a digital image in a standard image-data format, for example chosen from jpeg, png, tiff, raw and bmp, or to generate a film, for example in a standard format chosen from avi, mpeg and mkv, from which a chronological sequence of images may be extracted.

Preferably, in order to protect the cameras, at least one and preferably all the acquiring stages each comprise a casing in which the cameras of the acquiring stage are housed.

Preferably, the casings are a distance from one another.

Preferably, the spacing between the casings is adjustable.

Moreover, since the acquiring device may be intended to operate in a tunnel of a generally dark underground installation, the acquiring module preferably comprises a plurality of lamps for illuminating the scene. The lamps are in particular configured to illuminate the scene at least during the acquisition of the images.

Preferably, the maximum luminous power of at least one and preferably each lamp is higher than 900 lumens, and preferably higher than 1200 lumens.

Preferably, the lamps are distributed, preferably regularly, about the axis of the rod so that each portion of the scene seen by the camera is illuminated during the acquisition of the images in the most uniform possible way.

At least one and preferably all of the acquiring stages comprise lamps. In particular, at least two and preferably all the acquiring stages comprise the same number of lamps. For example, within an acquiring stage, each lamp is placed between two adjacent cameras.

Preferably, the lamps are identical and all emit light having an identical spectrum and an identical intensity.

The lamps may be configured to produce a flash of light during the image acquisition and/or to produce a continuous illumination that, preferably, is of constant intensity.

The color temperature may vary from 5000 K to 5500 K for example.

Preferably, the lamps are based on light-emitting diodes.

The lamps may be housed in the casing.

Moreover, the device may comprise a triggering unit connected to at least two and preferably all the cameras, and optionally to the lamps, and configured to trigger the acquisition of the images. The triggering unit may be connected to the cameras via an electrical cable or by means of a wireless link, for example of Bluetooth type.

The triggering unit may be configured to trigger a synchronous or quasi-synchronous acquisition of the images, i.e. the offset between the times at which all the cameras of the acquiring module are triggered following the trigger of the trigger is shorter than 100 ms.

Moreover, the triggering unit may comprise a pushbutton that, when it is actuated by the operator, commands the acquisition of the images. The rod may comprise a handle for gripping, on which the pushbutton may be mounted.

In one variant, the acquiring module comprises the triggering unit, which may be mounted on the rod or on an acquiring stage.

Preferably, the acquiring module has a weight lower than 15 kg, and better still lower than 10 kg. Thus, the device may be carried by an operator who may move it from scene to scene without using a handling device.

Moreover, the device may comprise an electrical supply unit, preferably comprising a rechargeable and for example removable battery, for supplying the acquiring module with power. In particular, the supply unit may supply the cameras and the lamps and/or the triggering unit with power.

The device may comprise a storage unit, for example a hard disk or an SD card, configured to receive and store the digital images delivered by the cameras. The storage unit may be connected by a cable or by a wireless link, for example a Wi-Fi link, to the cameras.

Moreover, the device may comprise a harness suitable for being worn by an operator, preferably on his back, during the movement of the acquiring module through the environment, in particular a tunnel.

The storage unit and/or the triggering unit and/or the supply unit may be mounted on the harness or housed in a sack mounted on the harness.

The device may comprise a plurality of rear cameras mounted on the harness, and placed such that when the harness is being worn by the operator and the latter is looking forward, the viewing axes of the rear cameras are oriented in a direction substantially opposite to the direction of observation of the operator. Thus, when the operator moves the acquiring module through the environment, for example a tunnel, in order to acquire the scene that he can see in front of him, the rear cameras acquire the scene already acquired at the preceding location, but from other viewpoints. The rear cameras thus facilitate the assembly of the digital elementary models generated by photogrammetry in two consecutive locations.

Preferably, the rear cameras are connected to the triggering unit and they are triggered at the same time as the cameras of the acquiring module are triggered.

Preferably, the device comprises a plurality of rear lamps, mounted on the harness, and arranged so as to illuminate the scene seen by the rear cameras.

Moreover, the device may furthermore comprise a satellite geo-positioning system, for example an augmented-accuracy GPS system, in order to geo-reference, in an absolute reference system, the location of an acquisition, when the device is used in the open air. The geo-positioning system may be mounted on the acquiring module.

By “absolute reference system” what is meant is a geodetic reference system in which it is possible to define the location of an object on Earth unequivocally. Its center is for example close to the center of gravity of the Earth, its two first axes are in the plane of the equator and its third axis is close to the axis of rotation of the Earth. The absolute reference system used in the context of the present invention may preferably be chosen from the following: Réseau Géodésique Français 1993 (RGF93), World Geodetic System (WGS84), International Terrestrial Rotational Service (ITRS) and European Terrestrial Reference System (ETRS).

Moreover, the invention relates to a method for acquiring a scene, preferably of at least one tunnel, preferably of an underground installation, comprising an acquiring step in which the rod is positioned substantially vertically and the acquisition of at least one scene by means of the device is then triggered.

Preferably, the acquiring method comprises moving the device to a plurality of locations and, in each location, implementing the acquiring step, the locations being chosen so that the scenes acquired in two consecutive locations overlap.

The locations may be located along an itinerary that is preferably travelled in a single direction. The length of this itinerary may be larger than 10 m, or even larger than 100 m, or even larger than 1 km.

In particular, the locations may be placed along an itinerary that passes through a plurality of interconnected tunnels of an underground network.

The invention also relates to a method for producing a 3-D digital model that is geo-referenced in an absolute reference system, of an underground installation, the underground installation comprising at least one underground tunnel and at least one manhole that opens at the bottom thereof into the tunnel and onto the surface via an access, the method comprising steps of:
a) moving through the tunnel and the manhole at least one image-acquiring device, preferably a device such as defined above, with, during the movement of the device, acquisition of overlapping scenes, at least one scene including at least one reference element that is geo-referenced in the absolute reference system, which element is located at the access or introduced into the manhole,
b) creating a 3-D elementary model of each scene imaged by the device,
c) assembling the 3-D elementary models in order to produce a continuous 3-D model of the tunnel and of the manhole,
d) geo-referencing the continuous 3-D model in the absolute reference system by virtue of the position previously geo-referenced, in the absolute reference system, of said reference element.

Each specific location of the tunnel and of the manhole may thus be precisely geo-referenced. By extension, a continuous 3-D model of the underground installation may be generated and precisely geo-referenced. Thus, in one variant in which the underground installation is a sewer network and the accesses to the sewer network are defined by manhole covers, the continuous 3-D model makes it possible, starting from a geo-referenced surface location, to simplify the planning of work to be done in the tunnel.

The underground installation may be chosen from a sewer network, a mine, an underground rail network, a water reservoir or another industrial complex. Preferably, the underground installation is a sewer network.

Preferably, the manhole extends vertically from the access to the tunnel. The tunnel may extend in a substantially horizontal direction.

Preferably, in step a) the movement is carried out, at least in the tunnel, following an itinerary in one direction, this simplifying the implementation of the method.

In step a), the acquiring device may be moved through a plurality of interconnected tunnels and/or through a plurality of manholes that open at the bottom thereof into the one or more tunnels and onto the surface via accesses that are spaced apart from one another. In particular, it is possible to move the device through more than two interconnected tunnels, and for example more than three interconnected tunnels.

Moreover, the tunnel may have a height comprised between 1.5 m and 3 m and/or a width comprised between 0.6 m and 5 m and/or a length comprised between 1 m and 100 m.

In step a), it is possible to acquire at least two scenes each including at least one element that is geo-referenced in the absolute reference system and that is located at each of the two respective accesses or introduced into each of the two respective manholes.

The average distance between two aforementioned consecutive locations is for example comprised between 30 m and 100 m.

Preferably, each elementary digital model is created in step b) by photogrammetry, by digitally correlating a plurality of images and preferably all of the images acquired at the corresponding location. To this end, it is possible to implement the software package PhotoScan developed by Agisoft. The assembling step, step c), may be carried out in the same way.

Preferably, in step d) the continuous 3-D model is geo-referenced in the absolute reference system by virtue of the positions previously geo-referenced, in the absolute reference system, of at least one and better still a plurality of reference elements, each located at an access or in a manhole. Thus, using various, previously geo-referenced, known surface positions of reference elements that are placed at accesses or in manholes that are spaced apart from one another, it is possible to correct potential errors during the assembly of the continuous 3-D model and to improve the precision with which it is geo-referenced in the absolute reference system.

Preferably, the reference element is a least one section of a removable manhole cover, blocking the access. For example, the reference element is the center of the manhole cover in the configuration in which the manhole cover blocks the access.

The continuous 3-D model, obtained at the end of step d), comprises a set of points the geometric coordinates of which represent virtually the tunnel and the access. The geometric coordinates may be geo-referenced, in the absolute reference system, with a precision higher than 20 mm, preferably higher than 10 mm, and for example of about 5 mm.

The continuous 3-D model may furthermore comprise, associated with each geometric coordinate of a point of the tunnel or of the access, the color of this point.

Moreover, the method may comprise displaying the continuous 3-D model via a screen, with recreation of perspective, or via a stereo display, or via an augmented-reality headset. In particular, the display of the continuous 3-D model may comprise the display of at least one virtual object chosen from a wall of a tunnel or of the manhole, a pipe placed in the tunnel or in the manhole, an access to the surface, an opening connecting two tunnels together, a ladder, a pump, etc. The display, in particular in color, of the continuous 3-D model thus allows the zones of the tunnel in which work must be planned to be more easily identified.

Preferably, the method comprises creating a continuous 3-D model of a road section placed between two manholes opening into the tunnel and comprising reference elements located at each of the two corresponding accesses or introduced into each of the two respective manholes, and geo-referencing a continuous 3-D model of the road section in an absolute reference system. Thus, the continuous 3-D model of the tunnel and of the manholes may be assembled with the continuous 3-D model of the road section. For example, in the variant in which the underground installation is a sewer network and the road section is a street or a set of streets of a town or city, it is possible to easily identify the underground topography associated with a specific position in the street.

The invention will possibly be better understood on reading the following detailed description of nonlimiting example embodiments thereof, and on examining the appended drawings, in which:

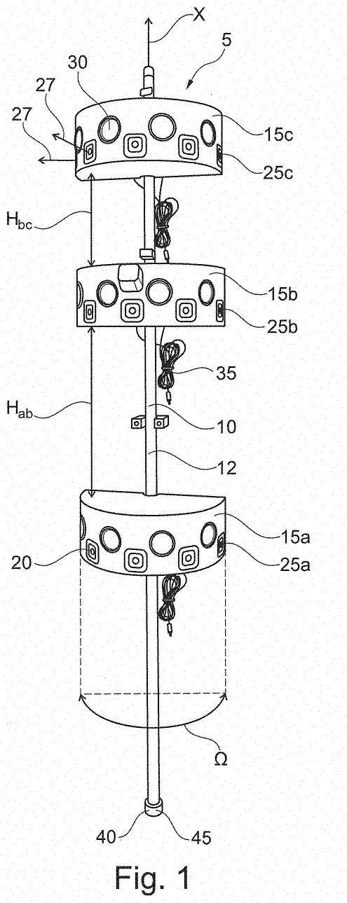

FIG. 1 schematically shows in perspective an example of an acquiring module of a device according to the invention,

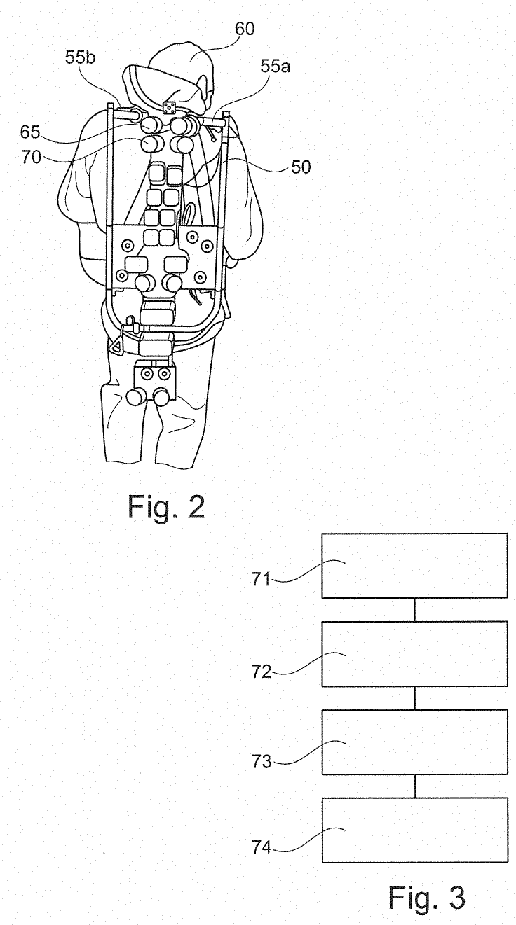

FIG. 2 illustrates an example of a harness according to the invention,

FIG. 3 schematically shows the steps of the invention,

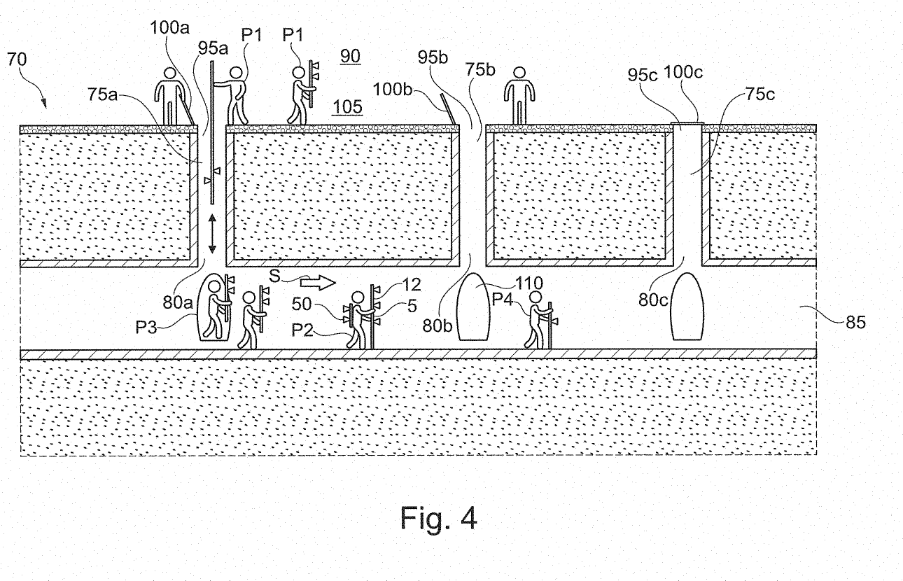

FIG. 4 schematically illustrates an example of implementation of the method for producing a geo-referenced 3-D digital model,

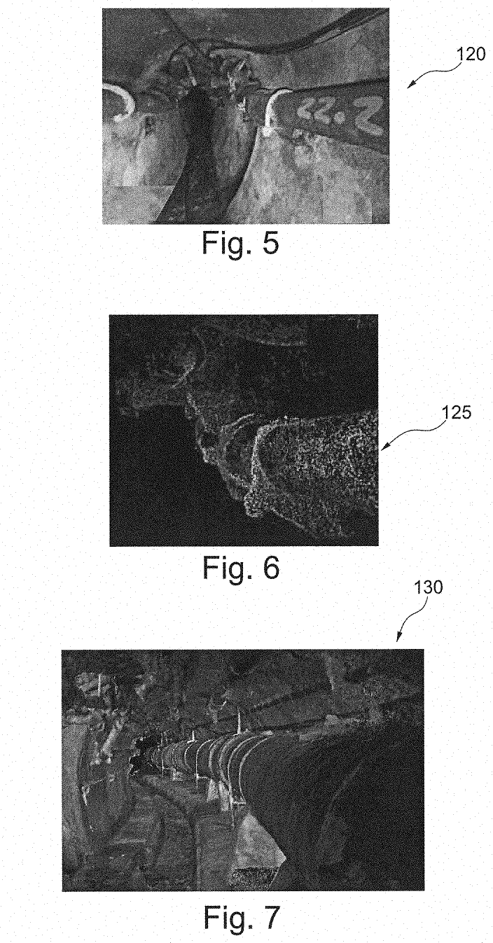

FIG. 5 shows an example of an image of a scene of a tunnel,

FIG. 6 is an example of a three-dimensional representation of an elementary 3-D model constructed from a plurality of images, and

FIGS. 7 to 9 are examples of display on a screen of a geo-referenced continuous 3-D model obtained by assembling elementary models such as illustrated in FIG. 6.

The device 5 according to the invention, which device is illustrated in FIG. 1, to comprises an acquiring module 10 for acquiring images.

The acquiring module comprises a rod 12 of longitudinal axis X and a plurality of casings 15a-c, in the present case three casings, mounted on the rod, and separated by a distance H_{ab}, H_{bc} from each other along the axis X. The casings each have a general semi-cylindrical shape, and for example of height and radius equal to about 20 cm and 15 cm, respectively.

Cameras 20 are housed in each casing, thus defining acquiring stages 25a-c placed at different heights on the rod 12. The spacing between two consecutive camera stages is adjustable and may be set to a value chosen by the user.

The cameras of each acquiring stage are placed angularly about the axis X over a total angular sector of angle Ω equal to 180°, so as to broadly cover the scene to be imaged. This value is nonlimiting.

The viewing axes 27 of the cameras of a given acquiring stage are distributed angularly about the axis X of the rod 12 so that the acquired images overlap angularly.

The cameras of each acquiring stage are placed regularly about the axis X over the total angular sector of angle Ω. In the example of FIG. 1, the acquiring stages comprise an identical number of cameras and the cameras are arranged in the same way in each stage, two cameras of given rank having coplanar viewing axes.

The cameras of each stage are moreover placed so that their viewing axes are contained in the same plane perpendicular to the axis X.

In the example of FIG. 1, the cameras are video cameras of trademark GoPro the objective of which, which opens onto the periphery of the casing in which said cameras are housed, is of 3 focal length and of 2.8 aperture.

The acquiring module moreover comprises light-emitting-diode lamps 30. These lamps are arranged within each acquiring stage and housed in the corresponding casings.

Each lamp is for example chosen to emit with a light intensity of 900 lumens. The lamps of a given acquiring stage are angularly distributed about the axis X and are each placed between two consecutive cameras. Each lamp thus illuminates a least one portion of the scene seen by the cameras between which it is placed.

Moreover, the acquiring module comprises electrical cables 35 connecting each camera and each lamp to a supply unit.

The rod 12 is preferably made of metal, for example of an aluminum alloy, or based on carbon fibers.

The rod has a foot 40 at its lower end, intended to make contact with the ground. The foot may be equipped with an anti-slip end fitting 45.

In the example of FIG. 1, the length of the rod may be varied, from about 0.30 m to 5 m. In one variant (not shown) the rod is telescopic, so that its foot may be shortened.

The acquiring device illustrated in FIG. 1 may furthermore comprise a harness. As illustrated in FIG. 2, the harness 50 comprises straps 55a-b in order to be carried on the shoulders of a wearer 60.

The device furthermore comprises a plurality of rear cameras 65 and a plurality of rear lamps 70, which rear cameras and rear lamps are mounted on the harness.

Moreover, the device comprises a battery, a bulk memory, for example an SSD disk, for storing the images, and a trigger for triggering the acquisition of the images by the cameras of the acquiring module and the rear cameras. As is illustrated in FIG. 2, the trigger, the battery and the hard disk are mounted on the harness. Thus the weight of the acquiring module is limited by avoiding mounting these elements, and in particular the supply unit, thereon. Handling of the acquiring module is simplified thereby.

FIG. 3 schematically shows the steps of the method according to the invention. In step a) 71, one or more operators move an acquiring apparatus, in particular such as described above, through at least one tunnel and one manhole of an underground installation so as to acquire at least one scene that includes a geo-referenced element. The images of each acquired scene are then stored and are digitally processed in step b) 72, for example by photogrammetry, in order to create an elementary 3-D model of the scene. In step c) 73, the models created for each scene are then assembled in order to produce a continuous 3-D model of the tunnel and of the manhole. Next, in step d) 74, by means of the position previously geo-referenced, in the absolute reference system, of the reference element, the continuous 3-D model of the tunnel and of the manhole is geo-referenced.

FIG. 4 schematically illustrates an example of use of the device according to the invention to acquire images of tunnels and of manholes of a sewer network.

The sewer network 70 comprises manholes 75a-c that are spaced apart from one another and that extend vertically. Each manhole opens, via its lower section, via a respective manhole junction 80a-c, into a substantially horizontal tunnel 85, and onto the surface 90 via a respective access 95a-c, which may be blocked by a removable manhole cover 100a-c.

In the configuration in which the manhole cover blocks the access, the position of the manhole cover, and preferably of its center, is geo-referenced in an absolute reference system.

The images may be acquired in the tunnel in the following way.

A first operator P1 positions, in a plurality of locations placed at different heights in one of the manholes, an image-acquiring device, in particular a device according to the invention, and acquires sets of images for each location in the manhole up to the manhole junction. In particular, he takes images of at least one scene comprising the access so as to be able to tally the position of the access in the continuous 3-D model to be generated from the acquired images, with a geo-referenced position of a reference element placed in the access, for example the center of the manhole cover in the position in which the manhole cover blocks the access.

A second operator P2, located under the manhole 75a in the tunnel, is equipped with a device according to the invention. He holds vertically in his hand the rod 12 of the acquiring module 10 illustrated for example in FIG. 1 and has on his back the harness 50 illustrated in FIG. 2. He moves along an itinerary in one direction, as indicated by the arrow S, through the tunnel. He positions himself at a location in the tunnel, then performs an acquisition of the scene that he observes. To this end, he positions the rod on the ground while holding it substantially vertically, and in such a way that the cameras of the acquiring module take images of the scene that he observes. Conjointly, he triggers the acquisition of the rear cameras placed on his back so as to acquire images of the scene acquired at the immediately preceding location. Once the acquisition has been performed, he moves by advancing through the tunnel to a new location that he will know how to choose so that the scene that he acquires therefrom is continuous with the scene acquired beforehand.

The second operator P2 may continue his progression through the tunnel to the next manhole junction 80b where he may then wait for the first operator to acquire images of the corresponding manhole. Once the manhole 75b has been acquired by the first operator, the second operator may then continue his itinerary and to acquire the scenes of the tunnel.

The implementation presented above is nonlimiting. For example, in one variant, the same operator may carry out the acquisition both in the manhole and in the tunnel.

Moreover, optionally, the first operator P1 may acquire, on the surface, preferably by means of the device according to the invention, images of at least one scene of a road section 105 connecting the accesses 95a, 95b of the two consecutive manholes 75a, 75b in order to generate a continuous 3-D model of the road section.

Optionally, a third operator P3, equipped with any suitable acquiring device, for example the same as that moreover used in the tunnel, may solely acquire the scenes present at the intersections 110 between the tunnels of the underground installation. A fourth operator P4 for his part may optionally note the coordinates of the bottom of the cunette of the tunnel.

FIG. 5 illustrates a photograph 120 such as acquired by a camera of the device according to the invention.

In step b) 72 of the method, all of the images acquired in a given location are processed by photogrammetry. An elementary 3-D model comprising a set of points of coordinates representative of the scene is thus created by means of photogrammetric processing of the images.

FIG. 6 is a 3-D view 125 of the coordinates of the points representative of the scene after photogrammetric processing. By assembling the elementary models, a continuous model of the tunnel is thus obtained, such as shown in the representation 130 of FIG. 7.

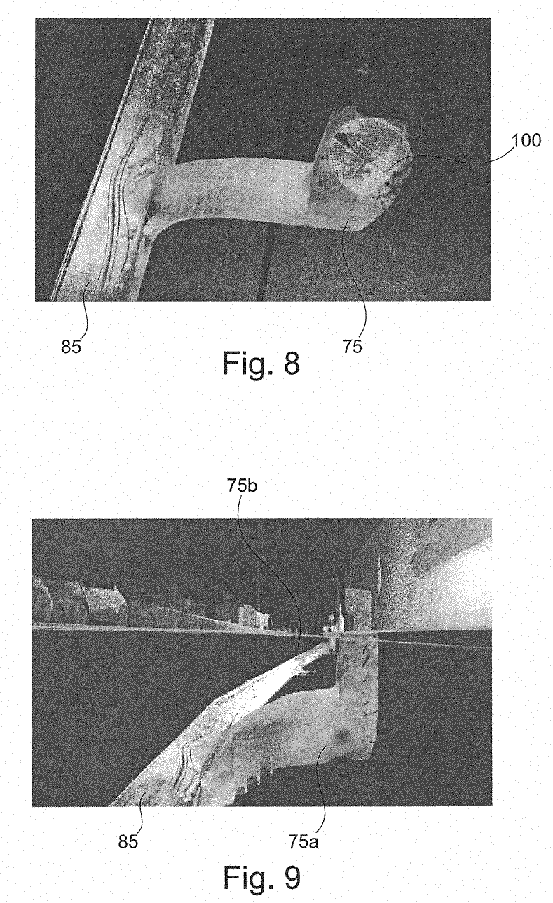

As was described above, the continuous 3-D model comprises the geo-referenced coordinates of the manhole 75 and of the tunnel 85. In FIG. 8, it may be seen that the coordinates of the points representative of the tunnel and of the access are precisely referenced with respect to the manhole cover 100, which defines a geo-referenced reference element.

Lastly, FIG. 9 illustrates an example of perfect continuity between a continuous 3-D model of a tunnel and of two manholes and the model of the road section between the two manholes obtained according to one implementation of the method according to the invention.

As reading the present description will have made clear, the geo-referenced continuous 3-D model obtained by means of the method according to the invention delivers a reliable and precise means for planning and optimizing the conditions of work in an underground installation.

Obviously, the invention is not limited to the embodiments and implementations of the invention described above.

1. A portable device for acquiring images of an environment, in particular a tunnel, the device comprising:
an acquiring module including a rod and at least two acquiring stages placed at different heights on the rod,
each of the at least two acquiring stages including a plurality of cameras configured to each acquire an image of a scene, viewing axes of the cameras of one of the at least two acquiring stages being angularly distributed over an axis of the rod so that the acquired images overlap angularly, a spacing between the at least two acquiring stages being adjustable.

2. The device according to claim 1, wherein the rod is carried by an operator and includes, in a lower portion thereof, a foot in contact with a ground.

3. The device according to claim 1, wherein the rod includes at least three acquiring stages.

4. The device according to claim 1, wherein the cameras of each of the at least two stages are distributed over a longitudinal axis of the rod, and over a total angular sector comprised between 90° and 210°.

5. The device according to claim 1, wherein the cameras of each of the at least two acquiring stages are fixed with respect to one another.

6. The device according to claim 1, wherein the acquiring module includes at least six cameras.

7. The device according to claim 1, wherein at least one of the at least two acquiring stages includes a casing in which the cameras of the at least one of the at least two acquiring stages are housed.

8. (canceled)

9. The device according to claim 1, wherein the acquiring module includes a plurality of lamps for illuminating the scene.

10. The device according to claim 1, wherein a weight of the acquiring module is lower than 15 kg.

11. The device according to claim 1, further comprising:
an electrical supply unit for supplying the acquiring module including the cameras with electrical power.

12. The device according to claim 1, further comprising:
a harness attached to the acquiring module, which is suitable for being worn by an operator, and
a plurality of rear cameras mounted on the harness.

13. The device according to claim 12, wherein the rear cameras are placed such that when the harness is being worn by the operator, viewing axes of the rear cameras are oriented in a direction opposite to a direction of observation of the operator.

14. The device according to claim 1, further comprising:
a fastening member for mounting the device on a vehicle.

15. A method for acquiring a scene of a tunnel, comprising:
acquiring the scene, using the device according to claim 1, wherein the rod is positioned in a substantially vertical direction.

16. The method according to claim 15, further comprising:
moving the device among a plurality of locations, wherein the locations are placed so that the scenes acquired in two consecutive locations overlap.

17. A method for producing a 3-D digital model of an underground installation, the 3-D digital model being geo-referenced in an absolute reference system, the underground installation including at least one underground tunnel and at least one manhole that connects a bottom of the tunnel to a surface via an access, the method comprising:
moving through the tunnel and the manhole at least one image-acquiring device, during the movement of the device, acquiring at least one scene including at least one reference element that is geo-referenced in the absolute reference system, the reference element being located at the access or in the manhole;
creating a 3-D elementary model of each scene imaged by the device;
assembling the 3-D elementary models in order to produce a continuous 3-D model of the tunnel and of the manhole; and
geo-referencing the continuous 3-D model in the absolute reference system, based on a position previously geo-referenced, in the absolute reference system, of said reference element.

18. The method according to claim 17, wherein, the device is moved through a plurality of interconnected tunnels or through a plurality of manholes that connect a bottom of the interconnected tunnels to the surface via accesses that are spaced apart from one another.

19. The method according to claim 17, further comprising:
acquiring at least two scenes each including at least one reference element that is geo-referenced in the absolute reference system, and that is located at each of the two respective accesses or in each of the two respective manholes.

20. The method according to claim 17, wherein each 3-D elementary digital model is created by photogrammetry and by digitally correlating a plurality of images.

21. The method according to claim 19, further comprising:
creating a continuous 3-D model of a road section placed between two manholes and including reference elements located at each of the two corresponding accesses or in each of the two respective manholes, and
geo-referencing the continuous 3-D model of the road section in an absolute reference system.

22. The method according to claim 17, wherein the continuous 3-D model includes a set of points, the geometric coordinates of the set of points representing virtually the tunnel and the access.

23. The method according to claim 22, wherein the geometric coordinates are geo-referenced, in the absolute reference system, with a precision higher than 20 mm.

24. The method according to claim 17, wherein the underground installation is chosen from a sewer network, a mine, an underground rail network, a reservoir of drinking water and another industrial complex.

25. The device according to claim 3, wherein the rod includes three acquiring stages.

26. The device according to claim 4, wherein the cameras of each stage is distributed over the longitudinal axis of the rod, and over a total angular sector comprised between 150° and 190°.

27. The device according to claim 6, wherein the acquiring module includes at least ten cameras.

28. The device according to claim 7, wherein each of the acquiring stages includes a casing in which the cameras of the acquiring stage are housed.

29. The device according to claim 28, wherein the casings are at a distance from one another.

30. The method according to claim 17, wherein the device is the portable device of claim 1.

31. The method according to claim 19, further comprising:
acquiring of geo-referencing the continuous 3-D model based on positions previously geo-referenced, in the absolute reference system, of at least one of said reference elements.
